(19) United States
(12) Patent Application Publication
(10) Pub. No.: US 2026/0365145 A1
(43) Pub. Date: Nov. 19, 2026

(54) Brake Torque Estimation Device

(71) Applicant: Astemo, Ltd., Chiyoda-ku, Tokyo (JP)

(72) Inventors: Shinji SETO, Tokyo (JP); Daisuke GOTO, Hitachinaka-shi, Ibaraki (JP)

(21) Appl. No.: 19/133,770

(22) PCT Filed: Dec. 4, 2023
(86) PCT No.: PCT/JP2023/043320

§ 371 Date: May 29, 2025

(30) Foreign Application Priority Data
Dec. 5, 2022 (JP) 2022-194237

(51) Int. Cl. B60T 8/172; B60T 1/06; B60T 8/171

(52) U.S. Cl. CPC B60T 8/172; B60T 1/065; B60T 8/171; B60T 2240/06

(57) ABSTRACT

The present invention provides a brake torque estimation device capable of accurately estimating brake torque at a low cost. A brake torque estimation device (20) according to the present invention can be installed in a vehicle (10) having a plurality of wheels (7) with tires, and comprises a brake torque calculation unit (26) that calculates a brake torque (Tbi) of the wheels (7). A wheel speed (Vwi) of the wheels (7) and a longitudinal acceleration (ax), which is acceleration in the longitudinal direction of the vehicle (10), are input to the brake torque estimation device (20). The brake torque calculation unit (26) calculates a vehicle speed (Vb), a tire longitudinal force (Fxi) of the wheels (7), and a slip rate of the wheels (7) on the basis of the wheel speed (Vwi), a tire load (Fzi) of the wheels (7), the longitudinal acceleration (ax), and tire characteristics of the wheels (7), and calculates the brake torque (Tbi) on the basis of the calculated tire longitudinal force (Fxi).

### TECHNICAL FIELD

The present invention relates to a brake torque estimation device used for vehicle motion control to estimate the brake torque of a vehicle.

### BACKGROUND ART

The vehicle motion control can more accurately control actuators mounted on a vehicle by accurately estimating the tire longitudinal force, slip rate, vehicle speed, and brake torque. For example, vehicle motion is controlled based on the estimated brake torque during braking. Brake torque is an important value for vehicle performance and can be found from tire longitudinal force, slip rate, and vehicle speed. A force sensor, for example, can improve the accuracy of estimating the brake torque but increases costs.

A method to estimate the tire longitudinal force is to find a slip rate based on a difference between the vehicle speed and the wheel speed. This method has problems in that estimation of a vehicle speed by integrating the longitudinal acceleration causes difficulty in the elimination of stationary errors and the addition of a sensor is costly.

For example, Patent Literature 1 proposes the conventional technique to estimate the braking force without using a vehicle speed or a force sensor. The brake device described in Patent Literature 1 includes: a ground load estimation unit that estimates the ground load on a wheel; a longitudinal braking force correction value calculation unit that estimates a longitudinal braking force ratio from angular velocity and ground load on the wheel during braking and calculates a longitudinal braking force correction value to control the braking force of the wheel based on the longitudinal braking force ratio; a horizontal braking force correction value calculation unit that calculates a horizontal braking force correction value to reduce a horizontal difference in the braking force of the wheel based on the wheel angular velocity during braking; and a command value calculation unit that calculates a braking force command value based on the braking force target value, the longitudinal braking force correction value, and the horizontal braking force correction value.

Non-Patent Literature 1 describes the technique to estimate a slip rate using an observer.

### CITATION LIST

### Patent Literature

Patent Literature 1: JP-A-2010-70022
Non-Patent Literature 1: Thanh Vo-Duy, Minh C. Ta, Slip Ratio Estimation for Traction Control of Electric Vehicles, 2018 IEEE Vehicle Power and Propulsion Conference (VPPC), p. 1-6

### SUMMARY OF INVENTION

### Technical Problem

The conventional techniques cause difficulty in accurately estimating the brake torque and, in particular, accurately estimating the tire longitudinal force, slip rate, and vehicle speed needed to estimate the brake torque.

The technology described in Patent Literature 1 uses the estimated wheel load to control the longitudinal braking forces and estimates the tire longitudinal force when at least one of the front and rear wheels generates approximately the same right and left braking forces. This technology makes it difficult to estimate the tire longitudinal force when there is a difference in braking forces between the right and left wheels.

The technology described in Non-Patent Literature 1 uses an observer to estimate the slip rate based on the wheel speed, its differential value, and the longitudinal acceleration. This technology uses the observer to ensure the estimation convergence but cannot ensure time-dependent accuracy and requires differential values for wheel speed. It is unclear whether to be able to estimate values needed for vehicle motion control other than the slip rate.

As described above, the conventional technology makes it difficult to accurately estimate the longitudinal tire force, slip rate, and vehicle speed and accurately estimate the brake torque. A brake torque sensor or a force sensor can improve the brake torque estimation accuracy. However, to prevent an increase in costs, there is a request to accurately estimate the brake torque using only sensors generally provided for a vehicle without using those sensors.

The object of the present invention is to provide a brake torque estimation device capable of highly accurately estimating the brake torque at a low cost.

### Solution to Problem

A brake torque estimation device according to the present invention can be provided for a vehicle including a plurality of wheels with tires, includes a brake torque calculation unit to calculate the brake torque of the wheel, and is supplied with a wheel speed of the wheel and longitudinal acceleration of the vehicle. The brake torque calculation unit calculates a vehicle speed, the tire longitudinal force of the wheel, and the slip rate of the wheel based on the wheel speed, tire load on the wheel, the longitudinal acceleration, and tire characteristics of the wheel and calculates the brake torque based on the calculated tire longitudinal force.

### Advantageous Effects of Invention

The present invention can provide a brake torque estimation device capable of highly accurately estimating the brake torque at a low cost.

### BRIEF DESCRIPTION OF DRAWINGS

FIG. 1 is a diagram illustrating the configuration of a vehicle including the brake torque estimation device according to a first embodiment of the present invention.

FIG. 2 is a block diagram illustrating the configuration of the brake torque estimation device according to the first embodiment.

FIG. 3 is a diagram illustrating the relationship between slip rate and friction coefficient as tire characteristics.

FIG. 4 is a diagram illustrating the relationship between slip rate and friction coefficient when a sideslip angle changes.

FIG. 5 is a block diagram illustrating the configuration of the brake torque estimation device according to a fourth embodiment of the present invention.

FIG. 6 is a diagram illustrating the configuration of a brake device.

FIG. 7 is a diagram illustrating the brake torque estimation device connected to a brake control device.

FIG. 8 is a block diagram illustrating the configuration of the brake control device according to an eighth embodiment of the present invention.

### DESCRIPTION OF EMBODIMENTS

The brake torque estimation device according to the present invention can be provided for a vehicle including a plurality of wheels with tires and can estimate tire characteristics (such as a braking coefficient) and tire load using the wheel speed of the wheels and the longitudinal acceleration of the vehicle. The estimated tire characteristics and tire load can be used to highly accurately estimate the vehicle speed, slip rate, longitudinal tire force, and brake torque at a low cost. Slip rate, longitudinal tire force, and brake torque are subject to individual variability depending on the brake devices and tires and vary with time-dependent changes due to wear of the brake devices and tires. The brake torque estimation device according to the present invention can highly accurately estimate vehicle speed, slip rate, longitudinal tire force, and brake torque at a low cost using only sensors generally provided for a vehicle, without using a brake torque sensor or a force sensor. The brake torque estimation device according to the present invention can highly accurately control vehicle motions at a low cost.

The description below explains the brake torque estimation device according to the embodiments of the present invention by referencing the drawings. Concerning the drawings used in the present specification, the same or corresponding constituent elements are designated by the same reference numerals and a repetitive explanation of these constituent elements may be omitted for simplicity.

### First Embodiment

The description below explains the brake torque estimation device according to the first embodiment of the present invention.

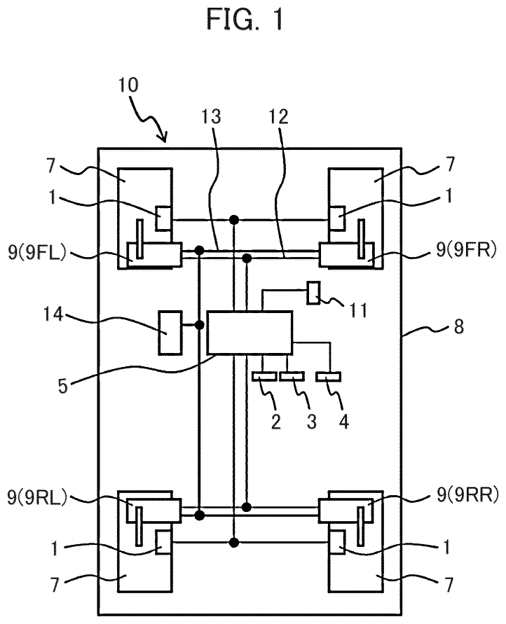

FIG. 1 is a diagram illustrating an example configuration of a vehicle 10 including the brake torque estimation device according to the present embodiment. The vehicle 10 includes a controller 5, wheels 7, a vehicle body 8, a wheel speed sensor 1, an acceleration sensor 2, a gyro sensor 3, a steering angle sensor 4, a brake device 9 to generate a braking force, a brake pedal 11, and a power source 14 as well as, although not shown, an internal combustion engine or electric motor to generate a braking/driving force, a steering device, and a suspension, for example.

The controller 5 includes the brake torque estimation device according to the present embodiment and controls the internal combustion engine, the electric motor, the brake device 9, the steering device, and the suspension, for example. The controllers 5 may be provided separately according to respective specific functions or may be provided separately as a high-order controller and a low-order controller. In the present specification, the plurality of separated controllers are collectively referred to as the controller 5. The controller 5 may be configured as a calculator that includes hardware such as an arithmetic device such as a CPU, a main storage device such as semiconductor memory, an auxiliary storage device, and a communication device, and controls the vehicle 10 in an integrated manner. The arithmetic device executes a program loaded into the main storage device to provide various functions.

The following description may omit the description of well-known technologies such as the above-described configuration of the controller 5.

The wheels 7 are placed at four locations on the front, rear, right, and left of the vehicle body 8 and include tires. According to the present embodiment, the vehicle 10 is assumed to be a four-wheel vehicle.

The wheel speed sensor 1, the acceleration sensor 2, the gyro sensor 3, and the steering angle sensor 4 are generally provided for the vehicle 10.

The wheel speed sensor 1 detects revolution speeds of the wheels 7 placed at four locations on the vehicle body 8. For example, the wheel speed sensor 1 can be configured as a sensor that detects the relative revolution speed (wheel angular velocity) between a rotating unit provided for an axle hub and a fixed unit provided for a knuckle or a brake carrier, for example.

The acceleration sensor 2 detects accelerations acting on the center of gravity of the vehicle body 8 such as an acceleration in the longitudinal direction (longitudinal acceleration) and an acceleration in the horizontal direction (horizontal acceleration) of the vehicle 10.

The gyro sensor 3 detects a yaw rate as an angular velocity of the rotation around the center of gravity of the vehicle body 8.

The steering angle sensor 4 detects the rotation angle of the steering wheel or the steering angle of the wheel 7, caused by the steering of a driver who drives the vehicle 10.

The brake device 9 is an electric brake device, for example, and is provided for each of the four wheels 7 on the vehicle body 8. Specifically, the vehicle 10 includes a brake device 9FL for the front left wheel, a brake device 9FR for the front right wheel, a brake device 9RL for the rear left wheel, and a brake device 9RR for the rear right wheel. These brake devices are equally structured and are controlled by the controller 5. Hereinafter, these brake devices 9FL, 9FR, 9RL, and 9RR are collectively referred to as the brake device 9. The brake device 9 may be a hydraulic brake device instead of an electric brake device.

The controller 5 transmits a control signal corresponding to the operation of the brake pedal 11 to the brake device 9 via the communication line 12 based on various information such as the operation of the brake pedal 11 by the driver of the vehicle 10, states of the vehicle 10 and the wheels 7, and the outside world of the vehicle 10. The brake device 9 is driven by power supplied from the power source 14 via the electric wire 13.

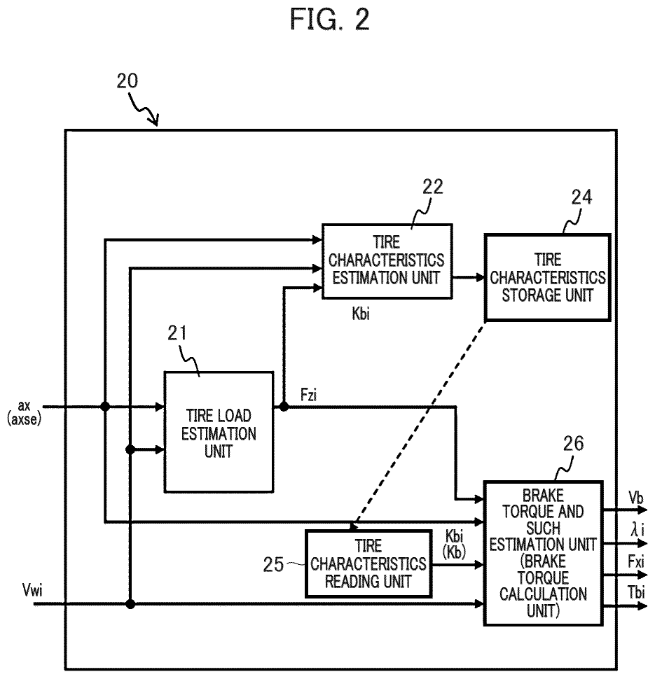

The controller 5 has the function of the brake torque estimation device according to the present embodiment and brakes the vehicle 10 using brake torque values, for example, estimated by the brake torque estimation device. The description below explains the brake torque estimation device according to the present invention in FIG. 2.

FIG. 2 is a block diagram illustrating the configuration of the brake torque estimation device 20 according to the present embodiment. The brake torque estimation device 20 includes a tire load estimation unit 21, a tire characteristics reading unit 25, a tire characteristics estimation unit 22 and a tire characteristics storage unit 24.

A tire load estimation unit 21 calculates and estimates tire load Fzi. The tire load Fzi is also referred to as tire vertical force Fzi. The method for the tire load estimation unit 21 to calculate the tire load Fzi will be described later.

The suffix i is an identifier to distinguish among the four wheels 7 on the vehicle body 8 and represents one of FL (front left wheel), FR (front right wheel), RL (rear left wheel), and RR (rear right wheel). The suffix i will be used in the following explanation.

The tire characteristics reading unit 25 is supplied with the tire characteristics stored in the tire characteristics storage unit 24. The tire characteristics are values that indicate the relationship between the slip rate and the friction coefficient of the tire. Examples of tire characteristics may include the braking coefficient Kbi which is a proportionality coefficient between the slip rate and the friction coefficient, as described later. The friction coefficient is a value found by dividing the longitudinal force (tire longitudinal force Fxi) applied to the tire on the tire contact area by the vertical force (tire load Fzi or tire vertical force Fzi) applied to the tire on the tire contact area.

The brake torque suchlike estimation unit 26 calculates and estimates the longitudinal tire force, slip rate, vehicle speed, and brake torque using the tire load Fzi calculated by the tire load estimation unit 21 and the tire characteristics (such as the braking coefficient Kbi, a value indicating the relationship between slip rate and friction coefficient) acquired by the tire characteristics reading unit 25. Hereinafter, the longitudinal tire force, slip rate, vehicle speed, and brake torque are also collectively referred to as “brake torque suchlike.” The brake torque suchlike estimation unit 26 is referred to as a brake torque calculation unit.

The description below explains the method for the brake torque suchlike estimation unit 26, a brake torque calculation unit, to calculate the brake torque suchlike.

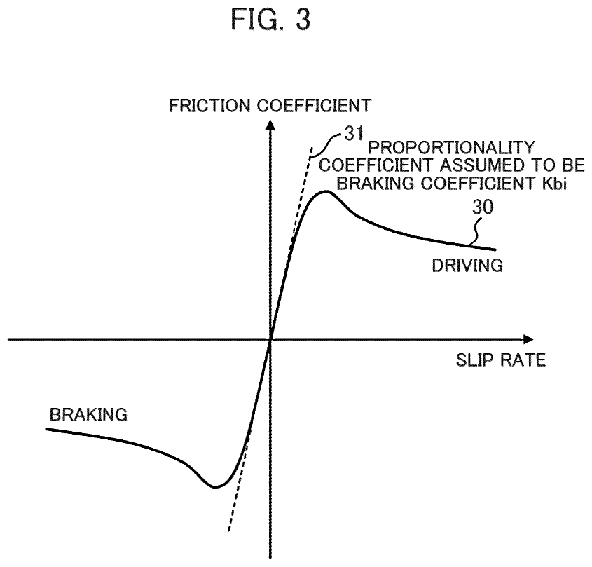

FIG. 3 is a diagram illustrating the relationship between slip rate and friction coefficient as tire characteristics. In FIG. 3, curve 30 represents the relationship between the slip rate on the horizontal axis and the friction coefficient on the vertical axis. It is generally known that the slip rate and the friction coefficient have a relationship illustrated in FIG. 3.

The slip rate λi during braking is expressed by equation (1).

$$[ Equation 1 ]$$

$${λ}_{i} = \frac{{V}_{wi} - {V}_{b}}{{V}_{b}} \qquad ( 1 )$$

Here, Vb denotes the vehicle speed, and Vwi denotes the wheel speed. The vehicle speed Vb is the speed of the vehicle body 8 (the speed at the center of gravity of the vehicle body 8). The wheel speed Vwi is the revolution speed of the wheel 7, found as “tire radius Ri×wheel angular velocity ωi,” and can be detected by the wheel speed sensor 1.

The slip rate λi during driving (acceleration) is expressed by equation (2).

$$[ Equation 2 ]$$

$${λ}_{i} = \frac{{V}_{wi} - {V}_{b}}{{V}_{b}} \qquad ( 2 )$$

In FIG. 3, the positive slip indicates the friction coefficient during driving, and the negative slip rate indicates the friction coefficient during braking. In the graph of FIG. 3, the upper right region indicates the characteristics during driving, and the lower left region indicates the characteristics during braking.

Characteristically as illustrated in FIG. 3, the friction coefficient increases as the slip rate increases, reaches a peak at a certain slip rate, and then decreases as the slip rate increases further. When the absolute value of the slip rate is small, there is a linear relationship between the slip rate and the friction coefficient. The relationship between the two is represented by a dashed line 31.

As described above, a small absolute value for the slip rate causes the proportional relationship between the slip rate and the friction coefficient. This proportionality coefficient is assumed to be the braking coefficient Kbi.

The tire longitudinal force Fxi is found by equation (3).

[Equation 3]

Fₓᵢ=K_{bi}λᵢF_{zi} (3)

The total value of the tire longitudinal force Fxi for all wheels 7 (four wheels) is expressed by equation (4) according to the equation of motion for the vehicle 10, excluding the effects of gravity due to air resistance or the tilt of the vehicle 10, for example.

[Equation 4]

Fₓᵢ=K_{bi}λᵢF_{zi} (3)

Here, ax denotes the longitudinal acceleration of the vehicle 10, axse denotes the longitudinal acceleration acting on the center of gravity of the vehicle body 8 detected by the acceleration sensor 2, and mb denotes the mass of the vehicle 10 including the occupants, for example. The symbol Σ denotes the sum of the subscript i, namely, the sum of all wheels 7 (four wheels).

As in equation (4), the longitudinal acceleration ax of the vehicle 10 may be replaced by the value axse detected by the acceleration sensor 2. The longitudinal acceleration ax of the vehicle 10 can be highly accurately found by eliminating gravitational acceleration components included in the longitudinal acceleration axse due to pitching of the vehicle body 8. Therefore, the longitudinal acceleration ax of the vehicle 10 can also be found by equation (5). Here, θy denotes the pitch angle of the vehicle body 8 and g denotes the gravitational acceleration.

$$[ Equation 5 ]$$

$${a}_{x} = \frac{{a}_{xse} + g sin {θ}_{y}}{cos {θ}_{y}} \qquad ( 5 )$$

When the pitch angle θy is small, equation (5) can be approximated to equation (6). For this reason, equation (5) may be replaced by equation (6) as a linear approximate equation on the assumption that the pitch angle θy is small.

[Equation 6]

aₓ=aₓₛₑ+gθ_{y} (6)

When the vehicle 10 is inclined at a tilt angle α, equation (4) as the equation of motion is expressed as equation (7) by the addition of a term for gravity.

[Equation 7]

ΣFₓᵢ=m_{b}aₓ−m_{b}g sin α (7)

When the pitch angle θy and the tilt angle α are assumed to be small, the longitudinal acceleration ax of the vehicle 10 can be found by equation (8) using the longitudinal acceleration axse detected by the acceleration sensor 2.

[Equation 8]

aₓ=aₓₛₑg(θ_{y}+α) (8)

Then, the total value of the tire longitudinal force Fxi for all wheels 7 (four wheels) can be found by equation (9) from equations (7) and (8) using the longitudinal acceleration axse detected by the acceleration sensor 2.

[Equation 9]

ΣFₓᵢ=m_{b}aₓₛₑ+m_{b}gθ_{y} (9)

Here, the pitch angle θy can be calculated using the relationship between the longitudinal acceleration and the pitch stiffness.

When the effect of air resistance is considered to calculate the tire longitudinal force Fxi, for example, equation (4) as the equation of motion can be used to find the total value of the tire longitudinal force Fxi for all wheels 7 (four wheels) as expressed in equation (10).

$$[ Equation 10 ]$$

$$\sum {F}_{xi} = {m}_{b} {a}_{xse} + \frac{1}{2} ρ A C {V}_{b}^{2} \qquad ( 10 )$$

Here, A denotes the frontal projected area of the vehicle 10, C denotes the air resistance coefficient, and ρ denotes the air density. The vehicle speed Vb is a value to be found (value included in the brake torque suchlike) and uses the most recently found value or the wheel speed Vwi in equation (10).

Equation (9) or (10) can more accurately find the total value of tire longitudinal force Fxi.

During braking, equation (11), resulting from assigning equation (1) to equation (3), expresses the total value of the tire longitudinal force Fxi for all wheels 7 (four wheels).

$$[ Equation 11 ]$$

$$\sum {F}_{xi} = \sum ( {K}_{bi} ( \frac{{V}_{wi}}{{V}_{b}} - 1 ) {F}_{zi} ) \qquad ( 11 )$$

Equation (11) is solved for the vehicle speed Vb to give equation (12) which expresses the vehicle speed Vb.

$$[ Equation 12 ]$$

$${V}_{b} = \frac{\sum ( {K}_{bi} {V}_{wi} {F}_{zi} )}{\sum {F}_{xi} + \sum ( {K}_{bi} {F}_{zi} )} \qquad ( 12 )$$

Equation (12) is assigned to equation (1) to obtain equation (13) which expresses the slip rate λi of each wheel.

$$[ Equation 13 ]$$

$${λ}_{i} = \frac{{V}_{wi} ( \sum {F}_{xi} + \sum ( {K}_{bi} {F}_{zi} ) ) - \sum ( {K}_{bi} {V}_{wi} {F}_{zi} )}{\sum ( {K}_{bi} {V}_{wi} {F}_{zi} )} \qquad ( 13 )$$

Equation (13) is assigned to equation (3) to obtain equation (14) which expresses the tire longitudinal force Fxi of each wheel.

$$[ Equation 14 ]$$

$${F}_{xi} = {K}_{bi} ( \frac{{V}_{wi} ( \sum {F}_{xi} + \sum ( {K}_{bi} {F}_{zi} ) ) - \sum ( {K}_{bi} {V}_{wi} {F}_{zi} )}{\sum ( {K}_{bi} {V}_{wi} {F}_{zi} )} ) {F}_{zi} \qquad ( 14 )$$

Consequently, it turns out that the vehicle speed Vb, the slip rate λi of each wheel, and the longitudinal tire force Fxi of each wheel can be found using the total value of tire longitudinal force Fxi for all wheels 7, the tire load Fzi (tire vertical force Fzi), the braking coefficient Kbi, and the wheel speed Vwi for each wheel 7, which can be calculated using the longitudinal acceleration axse detected by the acceleration sensor 2 (equations (12) through (14)).

The brake torque suchlike estimation unit 26 allows the braking coefficient Kbi to use the value input by the tire characteristics reading unit 25 from the tire characteristics storage unit 24 and allows the tire load Fzi for all wheels 7 to use the value estimated by the tire load estimation unit 21.

In the explanation above, different braking coefficients Kbi are used for all wheels 7 (four wheels) of the vehicle 10. If the four wheels 7 are considered to use the same tires and travel on road surfaces under similar conditions, it is possible to assume that there is no significant difference in the tire characteristics and the same braking coefficient Kb expresses the tire characteristics. If all wheels 7 have the same braking coefficient Kb, equations (12) through (14) are expressed as equations (15) through (17), respectively. Note that ΣFzi is replaced with mb×g.

$$[ Equation 15 ]$$

$${V}_{b} = \frac{{K}_{b} \sum ( {V}_{wi} {F}_{zi} )}{\sum {F}_{xi} + {m}_{b} {K}_{b} g} \qquad ( 15 )$$

$$[ Equation 16 ]$$

$${λ}_{i} = \frac{{V}_{wi} ( \sum {F}_{xi} + {m}_{b} {K}_{b} g ) - {K}_{b} \sum ( {V}_{wi} {F}_{zi} )}{{K}_{b} \sum ( {V}_{wi} {F}_{zi} )} \qquad ( 16 )$$

$$[ Equation 17 ]$$

$${F}_{xi} = \frac{{V}_{wi} ( \sum {F}_{xi} + {m}_{b} {K}_{b} g ) - {K}_{b} \sum ( {V}_{wi} {F}_{zi} )}{\sum ( {V}_{wi} {F}_{zi} )} {F}_{zi} \qquad ( 17 )$$

The vehicle speed Vb, the slip rate λi of each wheel, and the tire longitudinal force Fxi of each wheel can be calculated by replacing the braking coefficient Kbi of each wheel with the braking coefficient Kb using the same value for all wheels 7.

If travel resistance is ignored, the relationship between the tire longitudinal force Fxi the and brake torque during braking is expressed by equation (18).

[Equation 18]

Iᵢ\dot{ω}ᵢ=−T_{bi}−FₓᵢRᵢ (18)

Here, Ii denotes the inertia moment of the wheel 7, Tbi denotes the brake torque, Ri denotes the tire radius, and ωi denotes the wheel angular velocity. Note that the relationship ωi×Ri=Vwi is valid.

The brake torque Tbi can be calculated from equation (18) as expressed in equation (19).

[Equation 19]

T_{bi}=−Iᵢ\dot{ω}ᵢ−FₓᵢRᵢ (19)

The small inertia term in equation (19) is ignored to obtain equation (20) that expresses the brake torque Tbi.

[Equation 20]

T_{bi}=−FₓᵢRᵢ (20)

During deceleration, the tire longitudinal force Fxi is a negative value and the brake torque Tbi is a positive value.

The brake torque Tbi includes the brake torque due to the brake device 9, the torque due to the electric motor of an electric vehicle, and the torque due to an internal combustion engine. The torque due to the electric motor is referred to as the regenerative brake torque, and the torque due to the internal combustion engine is referred to as the engine brake torque. The regenerative brake torque and the engine brake torque are referred to as the driving torque. The brake torque suchlike estimation unit 26 can estimate these driving torques according to the conventional technology.

The brake torque suchlike estimation unit 26 can acquire the brake torque due to the brake device 9 by subtracting the driving torque (regenerative brake torque or engine brake torque) from the brake torque Tbi.

When the regenerative braking torque and the engine braking torque are sufficiently smaller than the brake torque due to the brake device 9, the brake torque suchlike estimation unit 26 can assume the value of the brake torque Tbi to be the value of the brake torque due to the brake device 9.

When the brake device 9 is inactive and the brake device 9 generates no brake torque, the brake torque suchlike estimation unit 26 can assume the value of the brake torque Tbi to be the value of the regenerative braking torque or the engine braking torque. When the brake torque generated by the brake device 9 can be measured, the brake torque suchlike estimation unit 26 can acquire the regenerative braking torque or the engine braking torque by subtracting the measured value of the brake torque due to the brake device 9 from the brake torque Tbi.

The description below explains a method for the tire load estimation unit 21 to calculate the tire load Fzi (tire vertical force Fzi). The tire load estimation unit 21 can use known methods to calculate the tire load Fzi. The description below explains an example method to calculate the tire load Fzi when the vehicle 10 travels straight.

For example, assume that the right and left wheels are equally loaded and there is no acceleration or deceleration. When the vehicle travels straight, the tire load Fzi can be calculated by equation (21) for the front wheels and equation (22) for the rear wheels.

$$[ Equation 21 ]$$

$${F}_{zFL} = {F}_{zFR} = \frac{{m}_{b}}{2} ( \frac{{L}_{R} - {h}_{yc} {a}_{x}}{{L}_{bas}} ) \qquad ( 21 )$$

$$[ Equation 22 ]$$

$$\begin{matrix}{F}_{zRL} = {F}_{zRR} = \frac{{m}_{b}}{2} ( \frac{{L}_{F} - {h}_{yc} {a}_{x}}{{L}_{bas}} ) & ( 22 )\end{matrix}$$

Here, mb denotes the mass of the vehicle 10 including the occupants, for example, Lf denotes the longitudinal distance between the center of gravity and the front wheel axle of the vehicle 10, Lr denotes the longitudinal distance between the center of gravity and the rear wheel axle of the vehicle 10, Lbas denotes the wheelbase (Lbas=Lf+Lr), and hyc denotes the height of the center of gravity of the vehicle 10.

Equations (21) and (22) can also calculate the tire load Fzi (tire vertical force Fzi) using the longitudinal acceleration axse detected by the acceleration sensor 2. The longitudinal acceleration ax is found using the longitudinal acceleration axse detected by the acceleration sensor 2 (see equations (4), (5), (6), and (8), for example).

As the tire load Fzi, the brake torque suchlike estimation unit 26 may use a value found by actual measurement or calculated based on the suspension displacement, for example, instead of the value calculated and estimated by the tire load estimation unit 21.

The description below explains the tire characteristics estimation unit 22. According to the present embodiment, the tire characteristics estimation unit 22 estimates the braking coefficient Kbi to find the tire characteristics. The present embodiment assumes all wheels 7 to have the same braking coefficient Kb (Kbi=Kb) and provides an example of finding this braking coefficient Kb.

It is known that the tire characteristics illustrated in FIG. 3 are almost equal except for a difference in the friction coefficient signs during braking and driving. The present embodiment provides a method of calculating the braking coefficient Kb during driving when the vehicle 10 is accelerating.

The explanation below uses an example of accelerating the vehicle 10 based on the front-wheel drive. The driving force of the rear wheels is zero, and the braking force is also zero. Assuming that the slip rate λi (i corresponds to RL and RR) of the rear wheels is zero, the vehicle speed Vb can be calculated using equation (23) obtained from equation (2).

[Equation 23]

V_{b}=V_{wRL}=V_{wRR} (23)

When equation (23) is assigned to equation (2), equation (24) finds the slip rate λFL of the front left wheel, and equation (25) finds the slip rate λFR of the front right wheel.

$$\begin{matrix}[ Equation 24 ] & \\ {λ}_{FL} = \frac{{V}_{wFL} - {V}_{wRL}}{{V}_{wFL}} & ( 24 )\end{matrix}$$

$$\begin{matrix}[ Equation 25 ] & \\ {λ}_{FR} = \frac{{V}_{wFR} - {V}_{wRR}}{{V}_{wFR}} & ( 25 )\end{matrix}$$

Based on equation (3), equations (26) and (27) express the tire longitudinal force FxFL of the front left wheel and the tire longitudinal force FxFR of the front right wheel, respectively. The slip rates λFL and λFR in equations (26) and (27) use the slip rates obtained from equations (24) and (25).

[Equation 26]

F_{xFL}=K_{b}λ_{FL}F_{zFL} (26)

[Equation 27]

F_{xFR}=K_{b}λ_{FR}F_{zFR} (27)

Assuming that the driving force and braking force of the rear wheels are zero, equation (28) expresses the total value of tire longitudinal force Fxi for all wheels 7 (four wheels).

[Equation 28]

ΣFₓᵢ=F_{xFL}+F_{xFR} (28)

The total value of tire longitudinal force Fxi on the left side of equation (28) can be calculated using the longitudinal acceleration axse detected by the acceleration sensor 2, as expressed in equation (4).

Equations (26) and (27) are assigned to the right term of equation (28), and equation (28) is solved for the braking coefficient Kb to obtain equation (29).

$$\begin{matrix}[ Equation 29 ] & \\ {K}_{b} = \frac{\sum {F}_{xi}}{{λ}_{FL} {F}_{zFL} + {λ}_{FR} {F}_{zFR}} & ( 29 )\end{matrix}$$

Namely, the braking coefficient Kb can be calculated using the longitudinal acceleration axse (or the longitudinal acceleration ax of the vehicle 10) detected by the acceleration sensor 2, the wheel speed Vwi of the four wheels used in equations (24) and (25), and the tire loads FzFL and FzFR of the front wheels.

There has been explained the example of the vehicle 10 using the front-wheel drive. The vehicle 10 using the rear-wheel drive can be explained by replacing the front wheels with rear wheels in the description above.

If the driving force of each wheel is known, the tire longitudinal force FxFL of the front left wheel and the tire longitudinal force FxFR of the front right wheel can be found. Equations (24) and (25) can find the slip rate λFL of the front left wheel and the slip rate λFR of the front right wheel. Therefore, the braking coefficient Kb can be found using equations (26) and (27).

The description below explains an example of the vehicle 10 using the four-wheel drive. Assume that equation (30) can detect or estimate the front-rear distribution of the driving force supplied to the wheels 7 from the engine or electric motor based on the four-wheel drive.

$$\begin{matrix}[ Equation 30 ] & \\ γ = \frac{{F}_{dxF}}{{F}_{dxR}} & ( 30 )\end{matrix}$$

Here, FdxF denotes the driving force of the front wheels, FdxR denotes the driving force of the rear wheels, and γ denotes the ratio between them.

The tire longitudinal forces FxFL and FxFR of the front wheels are found from the equation of motion of the vehicle 10 using equation (31).

$$\begin{matrix}[ Equation 31 ] & \\ {F}_{xFL} = {F}_{xFR} = \frac{{F}_{dxF}}{2 ( {F}_{dxF} + {F}_{dxR} )} \sum {F}_{xi} = \frac{γ}{( 2 γ + 1 )} \sum {F}_{xi} & ( 31 )\end{matrix}$$

Similarly, the tire longitudinal force FxRL of the rear left wheel and the tire longitudinal force FxRR of the rear right wheel are found using equation (32).

$$\begin{matrix}[ Equation 32 ] & \\ {F}_{xRL} = {F}_{xRR} = \frac{{F}_{dxR}}{2 ( {F}_{dxF} + {F}_{dxR} )} \sum {F}_{xi} = \frac{1}{2 ( γ + 1 )} \sum {F}_{xi} & ( 32 )\end{matrix}$$

Equation (33) is obtained from equations (2) and (3) for the front left wheel (i=FL). Equation (34) is obtained for the rear left wheel (i=RL) on the assumption of Kbi=Kb.

$$\begin{matrix}[ Equation 33 ] & \\ {F}_{xFL} = {K}_{b} \frac{{V}_{wFL} - {V}_{b}}{{V}_{wFL}} {F}_{zFL} & ( 33 )\end{matrix}$$

$$\begin{matrix}[ Equation 34 ] & \\ {F}_{xRL} = {K}_{b} \frac{{V}_{wRL} - {V}_{b}}{{V}_{wRL}} {F}_{zRL} & ( 34 )\end{matrix}$$

The simultaneous equations (33) and (34) are solved based on the vehicle speed Vb and the braking coefficient Kb, as unknowns, to obtain equation (35) which expresses the braking coefficient Kb.

$$\begin{matrix}[ Equation 35 ] & \\ {K}_{b} = \frac{{F}_{xF} {F}_{zRL} {V}_{wFL} - {F}_{xR} {F}_{zFL} {V}_{wRL}}{{F}_{zFL} {F}_{zRL} ( {V}_{wFL} - {V}_{wRL} )} & ( 35 )\end{matrix}$$

In the description above, the braking coefficient Kb expressed by equation (35) is found from equation (33) for the front left wheel and equation (34) for the left rear wheel. It may be also favorable to find the braking coefficient Kb from the equation for the front right wheel and the equation for the right rear wheel, the equation for the front left wheel and the equation for the right rear wheel, or the equation for the front right wheel and the equation for the left rear wheel. For example, equation (36) is obtained by finding the braking coefficient Kb from the equation for the front right wheel and the equation for the rear right wheel.

$$\begin{matrix}[ Equation 36 ] & \\ {K}_{b} = \frac{{F}_{xF} {F}_{zRR} {V}_{wFR} - {F}_{xR} {F}_{zFR} {V}_{wRR}}{{F}_{zFR} {F}_{zRR} ( {V}_{wFR} - {V}_{wRR} )} & ( 36 )\end{matrix}$$

The braking coefficient Kb can be found by a plurality of equations as described above. The average value of the braking coefficients K is obtained from a plurality of equations (such as two equations (35) and (36)) and is used as the value of the braking coefficient Kb, thereby also making it possible to more accurately find the braking coefficient Kb.

As described above, the tire characteristics estimation unit 22 calculates the braking coefficient Kb (or braking coefficient Kbi) as the tire characteristics. The tire characteristics estimation unit 22 may estimate the braking coefficient Kb at a predetermined time interval, considering that the tire characteristics change over time. The tire characteristics estimation unit 22 may average the braking coefficients Kb obtained from a plurality of estimations and use the averaged value as the value of the braking coefficient Kb to improve the accuracy of the braking coefficient Kb.

The tire characteristics storage unit 24 stores the tire characteristics found by the tire characteristics estimation unit 22. According to the present embodiment, the tire characteristics storage unit 24 stores the braking coefficient Kb (or braking coefficient Kbi) as the tire characteristics.

The brake torque estimation device 20 according to the present embodiment can estimate the braking coefficient Kb (Kbi) and the tire load Fzi (tire vertical force Fzi) as the tire characteristics using the wheel speed Vwi and the longitudinal acceleration ax (longitudinal acceleration axse) of the wheels 7 of the vehicle 10 and can calculate the vehicle speed Vb, slip rate λi, tire longitudinal force Fxi, and brake torque Tbi using the estimated braking coefficient Kb (Kbi) or tire load Fzi. The controller 5 controls the motion of the vehicle 10 using these values calculated by the brake torque estimation device 20. The brake torque estimation device 20 according to the present embodiment can highly accurately estimate the brake torque at a low cost and also highly accurately control the motion of the vehicle 10 at a low cost.

### Second Embodiment

The description below explains the brake torque estimation device according to the second embodiment of the present invention. The first embodiment has described the example of mainly traveling the vehicle 10 straight. The present embodiment describes a case of traveling the vehicle 10 while turning. When the vehicle 10 travels while turning, for example, the method of estimating the tire load Fzi differs from that when the vehicle 10 travels straight. The description below explains a method for the tire load estimation unit 21 to calculate the tire load Fzi when the vehicle 10 turns.

Since the turning vehicle 10 generates a roll motion, the tire load Fzi is expressed by equations (37) through (40).

$$\begin{matrix}[ Equation 37 ] & \\ {F}_{zFL} = \frac{{m}_{b}}{2} ( \frac{{L}_{R} g - {h}_{yc} {a}_{x}}{{L}_{bas}} - \frac{{h}_{yc} {a}_{y}}{{D}_{F}} ) & ( 37 )\end{matrix}$$

$$\begin{matrix}[ Equation 38 ] & \\ {F}_{zFR} = \frac{{m}_{b}}{2} ( \frac{{L}_{R} g - {h}_{yc} {a}_{x}}{{L}_{bas}} + \frac{{h}_{yc} {a}_{y}}{{D}_{F}} ) & ( 38 )\end{matrix}$$

$$\begin{matrix}[ Equation 39 ] & \\ {F}_{zRL} = \frac{{m}_{b}}{2} ( \frac{{L}_{F} g + {h}_{yc} {a}_{x}}{{L}_{bas}} - \frac{{h}_{yc} {a}_{y}}{{D}_{R}} ) & ( 39 )\end{matrix}$$

$$\begin{matrix}[ Equation 40 ] & \\ {F}_{zRR} = \frac{{m}_{b}}{2} ( \frac{{L}_{F} g + {h}_{yc} {a}_{x}}{{L}_{bas}} + \frac{{h}_{yc} {a}_{y}}{{D}_{R}} ) & ( 40 )\end{matrix}$$

Here, DF denotes the front wheel tread of the vehicle 10, DR denotes the rear wheel tread of the vehicle 10, and ay denotes the lateral acceleration of the vehicle 10.

The wheel speed, converted from each wheel speed into the longitudinal speed of the vehicle 10 at the sprung center of gravity, is found by adding or subtracting a speed difference in each wheel, caused by the turning motion, from each wheel speed based on actual steering angle δ or yaw rate r. Assuming that the wheel speed measured by the wheel speed sensor 1 is Vwsi, equations (41) through (44) express the wheel speed Vwi converted into the longitudinal speed of the vehicle 10 at the sprung center of gravity.

$$\begin{matrix}[ Equation 41 ] & \\ {V}_{wFL} = {V}_{wsFL} cos δ + \frac{1}{2} {D}_{F} r & ( 41 )\end{matrix}$$

$$\begin{matrix}[ Equation 42 ] & \\ {V}_{wFR} = {V}_{wsFR} cos δ - \frac{1}{2} {D}_{F} r & ( 42 )\end{matrix}$$

$$\begin{matrix}[ Equation 43 ] & \\ {V}_{wRL} = {V}_{wsRL} + \frac{1}{2} {D}_{R} r & ( 43 )\end{matrix}$$

$$\begin{matrix}[ Equation 44 ] & \\ {V}_{wRR} = {V}_{wsRR} - \frac{1}{2} {D}_{R} r & ( 44 )\end{matrix}$$

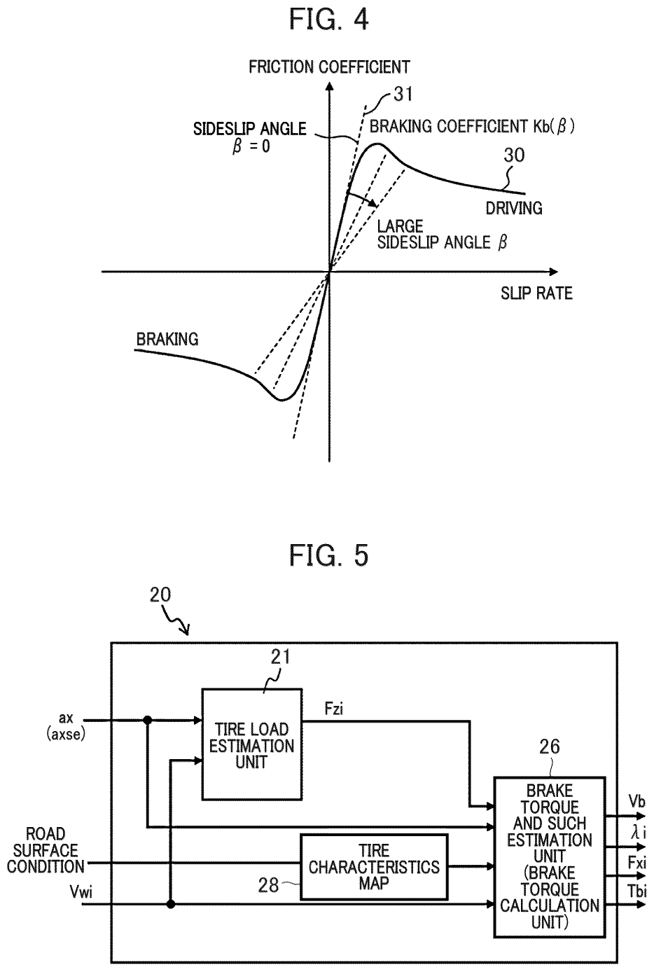

FIG. 4 is a diagram illustrating the relationship between slip rate and friction coefficient when a sideslip angle β changes. FIG. 4 illustrates the same curve 30 as that in FIG. 3. As explained in the first embodiment, the braking coefficient Kb is the proportionality coefficient between the slip rate and the friction coefficient in the range where the absolute value of the slip rate is small.

The braking coefficient Kb varies with the sideslip angle β when the vehicle 10 turns. As the sideslip angle β increases from zero, the change in the friction coefficient decreases relative to the change in the slip rate in the range where the absolute value of the slip rate is small. Consequently, the braking coefficient Kb, which is the proportionality coefficient between the slip rate and the friction coefficient, decreases as the sideslip angle β increases. The braking coefficient Kb depending on the value of the sideslip angle β is represented as Kb(β).

The tire characteristics reading unit 25 is supplied with the braking coefficient Kb as a function Kb(β) of the sideslip angle β from the tire characteristics storage unit 24. A conventional method can calculate the sideslip angle β using the steering angle (actual steering angle δ) and the vehicle speed Vb.

The brake torque suchlike estimation unit 26 replaces the braking coefficient Kb with Kb(β) and is supplied with the value of the wheel speed Vwi (equations (41) through (44)) converted into the longitudinal speed of the vehicle 10 at the sprung center of gravity, thereby making it possible to calculate the vehicle speed Vb, slip rate λi, tire longitudinal force Fxi, and brake torque Tbi using equations (12) through (20).

According to the first embodiment, the tire characteristics estimation unit 22 finds the braking coefficient Kb (0) when the sideslip angle β is zero. Based on this braking coefficient Kb (0), for example, experiments or numerical simulations can find the change in the value of the braking coefficient Kb when the sideslip angle β changes from zero (the change in the value of the braking coefficient Kb from Kb (0)). When the relationship between the sideslip angle β and the braking coefficient Kb is found in advance, the tire characteristics estimation unit 22 can also store this relationship as the braking coefficient Kb(β).

It may be favorable to previously find the sideslip angle β1 when the tire load Fzi is estimated while the vehicle 10 turns to find the braking coefficient Kb(β1) corresponding to this sideslip angle β1. Based on this braking coefficient Kb(β1), for example, experiments or numerical simulations can find the change in the value of the braking coefficient Kb when the sideslip angle β changes from β1 (the change in the value of the braking coefficient Kb from Kb(β1)) to previously find the relationship between the sideslip angle β and the braking coefficient Kb. The tire characteristics estimation unit 22 can also store this relationship as the braking coefficient Kb(β).

The present embodiment can calculate the tire characteristics (braking coefficient Kb) and the brake torque suchlike (vehicle speed Vb, slip rate λi, tire longitudinal force Fxi, and brake torque Tbi) when the vehicle 10 not only travels straight but also turns, making it possible to highly accurately estimate the brake torque Tbi at a low cost regardless of the traveling state of the vehicle 10.

### Third Embodiment

The description below explains the brake torque estimation device according to the third embodiment of the present invention.

The first embodiment has described the example case where the braking coefficient Kb, estimated by the tire characteristics estimation unit 22, and the braking coefficient Kb, estimated by the brake torque suchlike estimation unit 26, are assumed to be approximately the same without difficulty. Practically, the tire characteristics vary with not only the tires but also the condition of the road surface on which the vehicle 10 travels (hereinafter referred to as “road surface condition”).

The present embodiment describes an example in which the tire characteristics estimation unit 22 estimates tire characteristics (braking coefficient Kb) and the tire characteristics reading unit 25 is supplied with the braking coefficient Kb from the tire characteristics storage unit 24 considering the road surface condition. As explained in the first embodiment, the tire characteristics estimation unit 22 calculates and estimates the braking coefficient Kb during driving (acceleration). The braking coefficient Kb estimated by the tire characteristics estimation unit 22 will be represented as braking coefficient Kbe.

The tire characteristics estimation unit 22 acquires the road surface condition when estimating the braking coefficient Kbe. The road surface condition provides information on whether the road surface where the vehicle 10 travels is dry, wet, or snowy, for example. The tire characteristics estimation unit 22 acquires the road surface condition from various sensors (such as a front camera) provided for the vehicle 10 or from a server connected to the vehicle 10 via the Internet, for example. As the road surface condition, the tire characteristics estimation unit 22 can also acquire various information affecting the friction coefficient of the road surface, such as information on the weather (weather information) and the pavement (pavement information) on the road where the vehicle 10 travels. Such weather information and pavement information can be acquired along with position information using a map, for example.

The braking coefficient on a predetermined reference road surface is expressed as Kbs. Any road surface can be defined as the reference road surface. It may be favorable to define a good road surface (such as a dry road surface) as the reference road surface.

Equation (45) using the conversion coefficient c expresses the relationship between the braking coefficient Kbe, estimated by the tire characteristics estimation unit 22, and the braking coefficient Kbs on the reference road surface.

Kbs=c×Kbe (45)

The conversion coefficient c eliminates the effects of the road surface condition and takes different values depending on the road surface conditions (environment). The conversion coefficient c is predetermined corresponding to the road surface condition and is stored in the tire characteristics storage unit 24.

The braking coefficient Kbe is estimated by the tire characteristics estimation unit 22 under a specific road surface condition where the vehicle 10 travels. The braking coefficient Kbs for the reference road surface is found by multiplying the estimated braking coefficient Kbe by the conversion coefficient c according to equation (45), excluding the influence of the road surface condition (environment). This braking coefficient Kbs can be considered a tire-specific braking coefficient because the influence of the road surface condition is eliminated.

The tire characteristics estimation unit 22 previously finds the braking coefficient Kbs for the reference road surface from the previously estimated braking coefficient Kbe and stores the found braking coefficient Kbs in the tire characteristics storage unit 24. The tire characteristics reading unit 25 is supplied with the braking coefficient Kbs for the reference road surface stored in the tire characteristics storage unit 24.

As described in the first embodiment, the brake torque suchlike estimation unit 26 is supplied with the braking coefficient Kb as the tire characteristic from the tire characteristics reading unit 25 to estimate the brake torque suchlike. According to the present embodiment, the brake torque suchlike estimation unit 26 is supplied with the braking coefficient Kbs for the reference road surface from the tire characteristics reading unit 25 and finds the braking coefficient Kb according to equation (46). The conversion coefficient c uses a value corresponding to the road surface condition.

Kb=Kbs/c (46)

Considering the influence of the road surface condition, the brake torque suchlike estimation unit 26 uses the conversion coefficient c to calculate the braking coefficient Kb (braking coefficient to brake the vehicle 10) from the braking coefficient Kbs for the reference road surface.

Similar to the first embodiment, the brake torque suchlike estimation unit 26 uses the braking coefficient Kb found by equation (46) to estimate the brake torque suchlike.

The present embodiment can estimate the brake torque suchlike considering the tire characteristics (braking coefficient Kb) that also vary with the road surface conditions, making it possible to more accurately estimate the brake torque suchlike.

### Fourth Embodiment

The description below explains the brake torque estimation device according to the fourth embodiment of the present invention.

As indicated by the straight line 31 in FIG. 3, there is a linear relationship between the slip rate and the friction coefficient when the absolute value of the slip rate is small. Accordingly, the first embodiment assumes the proportionality coefficient for this relationship to be the braking coefficient Kb (tire characteristics). The first embodiment finds the tire characteristics in a linear region.

The present embodiment describes a method of finding the tire characteristics including a case where the relationship between the slip rate and the friction coefficient is non-linear (non-linear region). Specifically, the description below explains a method of finding the tire characteristics (relationship between the slip rate and the friction coefficient) including a case of expressing the relationship between the slip rate and the friction coefficient otherwise than the straight line 31 in FIG. 3.

FIG. 5 is a block diagram illustrating the configuration of the brake torque estimation device 20 according to a fourth embodiment of the present invention. Unlike the brake torque estimation device 20 according to the first embodiment (FIG. 2), the brake torque estimation device 20 according to the present embodiment includes a tire characteristics map 28 and excludes the tire characteristics estimation unit 22, the tire characteristics storage unit 24, and the tire characteristics reading unit 25.

The tire characteristics map 28 records tire characteristics including non-linear regions, namely, data on the relationship between the slip rate and friction coefficient represented by the curve 30 in the graph of FIG. 3, considering the influence of the tire types or road surface conditions (for each tire type and road surface condition), for example. The tire characteristics map 28 is generated previously and is provided for the brake torque estimation device 20.

The brake torque suchlike estimation unit 26 acquires the road surface condition, is supplied with data that is recorded in the tire characteristics map 28 and corresponds to the road surface condition, and performs numerical calculations to find tire characteristics including the non-linear region. The brake torque suchlike estimation unit 26 performs numerical analysis to find the slip rate λi that simultaneously satisfies equations (3) and (4). The brake torque suchlike estimation unit 26 can estimate the brake torque suchlike, including the tire characteristics in the non-linear region.

The present embodiment can calculate the brake torque suchlike considering the tire characteristics not only in the linear region but also in the non-linear region. It is possible to highly accurately estimate the brake torque suchlike even when the braking force is large and the relationship between the slip rate and the friction coefficient is non-linear, and further improve the control accuracy of the vehicle 10.

### Fifth Embodiment

The description below explains the brake torque estimation device according to the fifth embodiment of the present invention.

The present embodiment defines conditions for the brake torque suchlike estimation unit 26 described in the first through fourth embodiments to estimate the brake torque suchlike. For example, the brake torque suchlike estimation unit 26 estimates the brake torque suchlike only when any one of, a plurality of, or all of the following six conditions are satisfied.

1. The acceleration of the vehicle 10 (longitudinal acceleration) falls within a predetermined range.
2. The wheel speed Vwi falls within a predetermined range and the vehicle 10 is traveling straight.
3. The road surface where the vehicle 10 travels satisfies a predetermined condition (or the road surface condition remains unchanged when the braking coefficient Kb was estimated).
4. The regenerative brake torque (driving torque) generated by the electric motor is smaller than a predetermined threshold value.
5. The engine brake torque (driving torque) generated by the internal combustion engine is smaller than a predetermined threshold value.
6. The brake device 9 is active or inactive.

The brake torque suchlike estimation unit 26 can highly accurately estimate the brake torque suchlike only when at least one of these six conditions is satisfied, for the following reason.

The description below explains condition 1. The brake torque suchlike can be estimated highly accurately when the tire characteristics fall within a linear range (such as the range indicated by the straight line 31 in FIG. 3), namely, a range where the driving torque (regenerative brake torque or engine brake torque) is not large. For this reason, the brake torque suchlike is estimated when the acceleration of the vehicle 10 falls within a predetermined range and the driving torque is not large. For example, the predetermined range can be defined as the upper limit of acceleration (including deceleration) such as the deceleration of 4 m/s2 or less.

To calculate only the brake torque generated by the brake device 9, it is necessary to subtract the driving torque (regenerative brake torque or engine brake torque) from the estimated brake torque Tbi, as explained in the first embodiment. It is possible to reduce the influence of the driving torque and highly accurately estimate the brake torque generated by the brake device 9 by adding the conditions that the brake device 9 is active (condition 6) and the deceleration is 1 m/s2 or more (condition 1).

The description below explains condition 2.

In many cases, the wheel speed sensor 1 uses the system that reads rotating shaft pulses. At low speeds, the wheel speed sensor 1 degrades the measurement accuracy and the detection accuracy of the wheel angular velocity ωi. Considering this, it may be favorable to add a condition that the wheel speed Vwi falls within a specified range (such as 20 km/h or higher). As the speed increases, the effect of air resistance increases. To reduce the effect of air resistance, it is also possible to add a condition that the wheel speed Vwi falls within a specified range (such as 60 km/h or lower). The effect of air resistance is expressed in the second term on the right side of equation (10). However, the air resistance found by equation (10) contains an error. The addition of the condition to provide the wheel speed Vwi with an upper limit value (such as 60 km/h) can reduce the effect of an error even if contained in the found air resistance.

The condition that the vehicle 10 is traveling straight aims at eliminating the effect of turning of the vehicle 10. When the vehicle 10 turns, it is necessary to convert the tire load Fzi and the wheel speed Vwi due to the effect of steering (equations (37) through (40) and (41) through (44)) as explained in the second embodiment. The value found by this conversion contains an error. Consequently, it may be favorable to add a condition that the vehicle 10 is not turning, namely, the vehicle 10 is traveling straight.

The description below explains condition 3.

Even if the same information expresses the road surface condition, the actual condition of the road surface where the vehicle 10 travels may differ depending on the road surface. For example, even if the road surface condition is wet road, the actual wetness of the road surface as well as the friction coefficient may differ depending on the road surface. The limitation of the road surface condition to a specific road surface condition (such as a dry road) can prevent the accuracy of estimating the brake torque suchlike from degrading. It is possible to prevent the accuracy of estimating the brake torque suchlike from degrading due to differences in road surface conditions by estimating the brake torque suchlike under the same road surface condition as that for estimating the braking coefficient Kb.

The description below explains conditions 4 and 5.

The condition that the regenerative brake torque or engine brake torque (driving torque) is smaller than a predetermined threshold is used to estimate the brake torque generated by the brake device 9. It is not always possible to accurately estimate the torque generated by the electric motor (regenerative brake torque) and the torque generated by the internal combustion engine (engine brake torque). Even if the accuracy of estimating the driving torque is reduced, it is possible to accurately estimate the brake torque generated by the brake device 9 by estimating the brake torque suchlike when these driving torques are smaller than a predetermined threshold. When the vehicle 10 using an internal combustion engine indicates a low engine speed and the engine brake torque smaller than a predetermined threshold, for example, it is possible to decrease the influence of the brake device 9 on the estimation of the brake torque even if the accuracy of estimating the engine brake torque is reduced.

The description below explains condition 6.

The condition that the brake device 9 is inactive is used to calculate the regenerative brake torque or the engine brake torque. When the brake device 9 is inactive, the brake device 9 does not generate the brake torque. The estimated brake torque Tbi is assumed to be the regenerative brake torque or the engine brake torque, making it possible to highly accurately estimate these driving torques. The condition that the brake device 9 is active is used to calculate the brake torque generated by the brake device 9.

The above conditions 1 through 6 enable the brake torque suchlike estimation unit 26 to highly accurately estimate the brake torque suchlike.

Similar to the brake torque suchlike estimation unit 26, the tire characteristics estimation unit 22 may also estimate tire characteristics only when any one of, a plurality of, or all of the six conditions above are satisfied. Consequently, the tire characteristics estimation unit 22 can highly accurately estimate tire characteristics.

### Sixth Embodiment

The present embodiment explains an example of using the brake torque Tbi calculated in the first through fifth embodiments for brake control. The controller 5 controls the brake device 9 of the vehicle 10 using values of the brake torque Tbi estimated by the brake torque estimation device 20, for example. The description below explains an example of the brake device 9 which is a motor-controlled electric brake device. The controller 5 includes a brake control device to be described later and controls the brake device 9 using values of the brake torque Tbi, for example.

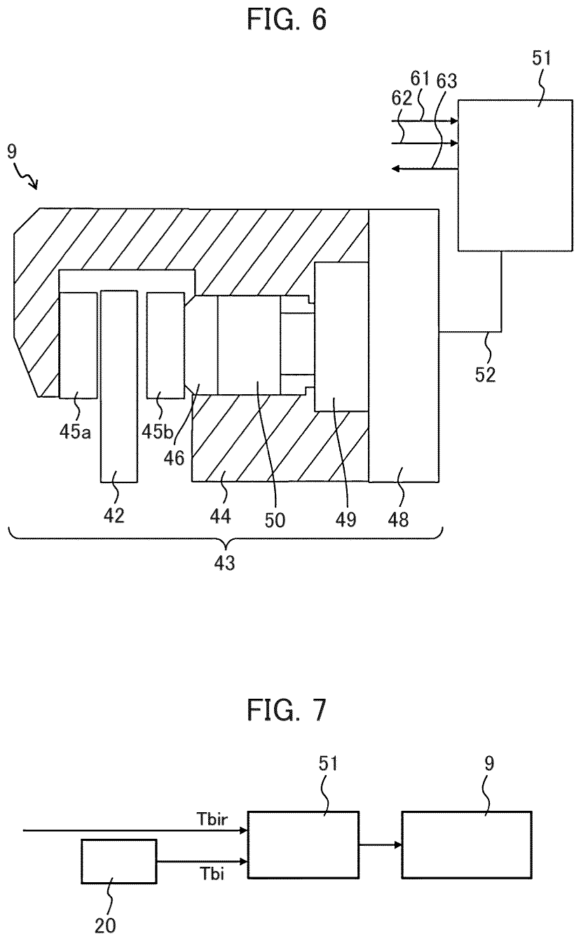

FIG. 6 is a diagram illustrating the configuration of a brake device 9. The brake device 9 includes main components such as a disc rotor 42, a housing 44, brake pads 45a and 45b, a piston 46, a rotary-to-linear conversion mechanism 50, and an electric motor 48.

The disc rotor 42 is a rotating member that rotates along with the wheel 7 and, when pressed from both sides by the brake pads 45a and 45b, stops the rotation of the wheel 7 by frictional force.

The housing 44 is a member that is supported on a carrier (unshown) secured to a non-rotating unit of the vehicle 10 located on the inside of the vehicle 10 away from the disc rotor 42 and is movable in the axial direction of the disc rotor 42.

The brake pads 45a and 45b are pressing members that are located on both sides of the disc rotor 42 and press the disc rotor 42 to apply braking force to the wheels 7.

The piston 46 is installed in the housing 44 to be able to move linearly and can apply force to the brake pads 45a and 45b.

The rotary-to-linear motion conversion mechanism 50 converts the rotational force of the electric motor 48 into linear motion force and moves the piston 46 in the linear motion direction.

The electric motor 48 drives the piston 46 via the rotary-to-linear motion conversion mechanism 5 and applies force to the brake pads 45a and 45b. The output shaft of the electric motor 48 is connected to a reducer 49. The output shaft of the reducer 49 is connected to the rotary-linear conversion mechanism 50.

The electric motor 48 applies force to the brake pads 45a and 45b which then press both sides of the disc rotor 42 rotating along with the wheel 7. This pressing force applies a braking force to the wheel 7 to brake the vehicle 10.

According to the present embodiment, a brake caliper 43 of the brake device 9 includes the disc rotor 42, the housing 44, the brake pads 45a and 45b, the piston 46, the electric motor 48, the reducer 49, and the rotary-linear conversion mechanism 50. The rotary-linear conversion mechanism 50 and the piston 46 configure a linear motion unit.

The electric motor 48 is controlled by a brake control device 51 provided for the controller 5.

The brake control device 51 connects with a control signal line 61 and communication lines 62 and 63. The control signal line 61 supplies the brake control device 51 with control commands from a higher-order control device such as a vehicle control ECU (Electronic Control Unit). The communication lines 62 and 63 are signal lines for transmitting information other than control commands to the higher-order control device. The brake control device 51 also connects with a control signal line 52. The control signal line 52 supplies the brake device 9 with control commands from the brake control device 51.

The brake control device 51 controls the brake device 9. The brake control device 51 is supplied with a brake torque command Tbir from a higher-order control device (such as a vehicle control ECU) or a brake torque command Tbir corresponding to the amount of operation of the brake pedal and applies an electric current (command current) to the electric motor 48 according to a predetermined control program based on the detection values from a motor current detection unit (current sensor) and a motor position detection unit (motor position sensor).

FIG. 6 illustrates an example configuration of separating the brake control device 51 from the higher-order control device. It may be also favorable to provide the controller 5 with an integration of the higher-order control device and the brake control device 51.

The brake control device 51 is connected to the brake torque estimation device 20 according to the present embodiment.

FIG. 7 is a diagram illustrating the brake torque estimation device 20 connected to a brake control device 51. The brake control device 51 is supplied with the brake torque command Tbir from the higher-level control device or with the same corresponding to the amount of operation of the brake pedal, and the brake torque Tbi estimated by the brake torque estimation device 20 and uses these values to generate and output a command to the brake device 9.

The brake control device 51 provides feedback control so that the estimated brake torque Tbi approaches the brake torque command Tbir, thereby controlling the brake device 9.

The present embodiment has described the example of the brake device 9 as an electric brake device controlled by a motor. The brake device 9 may be a hydraulic brake device including a control valve to control pressure. The brake device 9 as the hydraulic brake device can also provide the same control as for the electric brake device.

Even without the use of a force sensor (such as a sensor to measure the force pressing the brake pads 45a and 45b against the disc rotor 42), the present embodiment can provide feedback control so that the estimated brake torque Tbi is used as the commanded brake torque (brake torque command Tbir), making it possible to highly accurately control the brake torque at a low cost.

### Seventh Embodiment

Similar to the sixth embodiment, the present embodiment explains an example of using the brake torque Tbi calculated in the first through fifth embodiments for brake control.

According to the method described in the first embodiment, for example, the brake torque estimation device 20 estimates the brake torque Tbi when the tire characteristics fall within a linear range (such as the range represented by the straight line 31 in FIG. 3) and the vehicle 10 is traveling straight. Therefore, the brake torque estimation device 20 may have difficulty in accurately estimating the brake torque Tbi depending on the tire characteristics and the traveling states of the vehicle 10.

According to the present embodiment, when the brake torque estimation device 20 estimates the brake torque Tbi, the brake control device 51 (FIG. 7) stores the current I of the electric motor 48 of the brake device 9 (FIGS. 6 and 7) by setting the brake torque to an intended value using this current I to control the brake device 9. This current I is the value when the brake torque estimation device 20 estimates the brake torque Tbi, and can be acquired by a current sensor provided for the electric motor 48, for example.

Generally, the brake torque Tb is approximately proportional to the current I minus the current value I0 used for friction in the brake device 9. This proportionality coefficient K is expressed as K=Tb/(I−I0). The current value I0 is used for friction in a mechanism such as the rotary-to-linear conversion mechanism 50 and can be calculated from a current when the electric motor 48 is driven in a free-running state until the brake pads 45a and 45b come into contact with the disc rotor 42, for example.

When the current value I0 is previously found by an experiment or a numerical simulation, for example, the brake control device 51 can find the proportionality coefficient K from this current value TO, the stored current I, and the brake torque Tbi estimated by the brake torque estimation device 20. The brake control device 51 uses the brake torque command Tbir as a commanded brake torque to calculate the command current Ir for driving the electric motor 48, namely, Ir=1/K×Tbir+T0, making it possible to set the brake torque to an intended value (the value of the brake torque command Tbir). The brake control device 51 uses the command current Ir to control the rotational position of the electric motor 48 to an intended position and sets the brake torque to an intended value.

The present embodiment can highly accurately control the brake device 9 regardless of the tire characteristics or how the vehicle 10 travels.

### Eighth Embodiment

The seventh embodiment has described the example of controlling the brake device 9 (FIG. 6) by setting the brake torque to an intended value using the current of the electric motor 48.

The present embodiment describes an example of controlling the brake device 9 using the relationship between the brake torque and the rotational position of the electric motor 48. When the rotational position of the electric motor 48 changes, the positions of the brake pads 45a and 45b change to vary the brake torque.

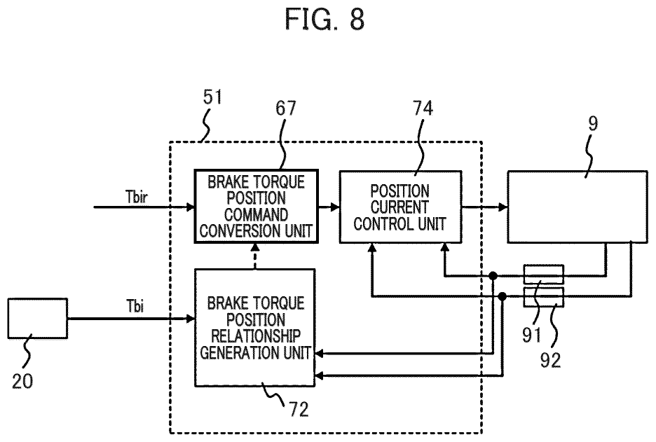

FIG. 8 is a block diagram illustrating the configuration of the brake control device 51 according to the present embodiment. The brake control device 51 includes a brake torque position relationship generation unit 72, a brake torque position command conversion unit 67 and a position current control unit 74. The brake device 9 connecting with the brake control device 51 includes a motor position sensor 92 provided for the electric motor 48 and a current sensor 91 described in the seventh embodiment.

The brake torque position relationship generation unit 72 stores the rotational position of the electric motor 48 of the brake device 9 when the brake torque estimation device 20 estimates the brake torque Tbi. This rotational position is a value when the brake torque estimation device 20 estimates the brake torque Tbi, and is acquired by the motor position sensor 92 provided for the electric motor 48, for example. The brake torque position relationship generation unit 72 is supplied with the brake torque Tbi estimated by the brake torque estimation device 20 and can record a map representing the relationship between the brake torque Tbi and the stored rotational position of the electric motor 48. The brake control device 51 can thus acquire the relationship between the brake torque and the rotational position of the electric motor 48.

The brake torque position command conversion unit 67 is supplied with the brake torque command Tbir as the commanded brake torque and references the map recorded by the brake torque position relationship generation unit 72 to represent the relationship between the brake torque and the rotational position of the electric motor 48. The brake torque position command conversion unit 67 is supplied with the brake torque command Tbir and then uses this map to convert the brake torque command Tbir into the rotational position of the electric motor 48.

The position current control unit 74 converts the rotational position of the electric motor 48, converted by the brake torque position command conversion unit 67, into a command current that provides this rotational position. The position current control unit 74 supplies the converted command current to the electric motor 48 of the brake device 9.

The present embodiment controls the brake torque based on the rotational position of the electric motor 48, unlike the seventh embodiment which controls the brake torque by controlling the value of the command current Ir. The present embodiment finds the command current based on the rotational position of the electric motor 48, making it possible to control the brake torque without using a torque constant whose value varies with temperature and therefore without being affected by temperature and more accurately control the brake device 9.

### Ninth Embodiment

When the relationship between the brake torque and the rotational position of the electric motor 48 is always constant, the eighth embodiment can use the command current Ir to control the rotational position of the electric motor 48 to an intended position and generate the brake torque corresponding to an intended value. Practically, however, the value of the brake torque varies with the friction coefficient pp of the brake pads 45a and 45b. The friction coefficient pp applies to the relationship between the disc rotor 42 and the brake pads 45a and 45b and is mainly expressed in terms of a function of the temperature T of the brake pads 45a and 45b and the revolution speed v of the disc rotor 42. The revolution speed v denotes the relative speed between the disc rotor 42 and the brake pads 45a and 45b.

The present embodiment uses experiments or numerical simulations, for example, to previously find changes in the brake torque due to changes in the temperature T and changes in the brake torque due to changes in the revolution speed v. The brake control device 51 stores the previously found changes in the brake torque due to changes in the temperature T and the revolution speed v.

The brake torque indicates a value resulting from multiplying the force, generated by the electric motor 48, by the friction coefficient pp between the disc rotor 42 and the brake pads 45a and 45b. Generally, the friction coefficient varies with the temperature or relative speed of the two objects in contact. The brake control device 51 estimates or measures and stores the temperature T of the brake pads 45a and 45b and the revolution speed v of the disc rotor 42.

The brake control device 51 stores the temperature T of the brake pads 45a and 45b and the revolution speed v of the disc rotor 42 when the brake torque estimation device 20 estimates the brake torque Tbi. The brake control device 51 finds and stores the temperature T and revolution speed v by estimating the temperature T and revolution speed v based on a record of how much the brake pads 45a and 45b and the disc rotor 42 have operated up to now or measuring the temperature T and revolution speed v using a sensor, for example.

The brake control device 51 uses previously found changes in the brake torque due to changes in the temperature T and the revolution speed v to estimate a brake torque value from the temperature T and revolution speed v found when estimating the brake torque Tbi, considering changes in the friction coefficient pp (changes in the temperature T and the revolution speed v).

The present embodiment can more accurately control the brake device 9 according to the temperature T of the brake pads 45a and 45b and the revolution speed v of the disc rotor 42.

### Tenth Embodiment

The first through ninth embodiments have described the examples of the four-wheel vehicle 10. The present embodiment describes examples of the two-wheel vehicle 10.

Similar to the four-wheel vehicle, the vehicle 10 including the brake torque estimation device 20 according to the present embodiment includes the controller 5, the wheel speed sensor 1, the acceleration sensor 2, the gyro sensor 3, the steering angle sensor 4, wheels 7, the vehicle body 8, the brake device 9 to generate a braking force, an internal combustion engine or an electric motor to generate a braking/driving force, a steering device, and a suspension, for example. The controller 5 includes the brake torque estimation device 20 according to the present embodiment and controls the internal combustion engine, the electric motor, the brake device 9, the steering device, and the suspension, for example. The wheels 7 are provided at two locations, front and rear, of the vehicle body 8 and include tires.

Equations (1) through (3) also hold true for the two-wheel vehicle 10 as described in the first embodiment. The subscript i is an identifier to distinguish between the wheels 7 at the front and rear of the vehicle body 8 and represents either F denoting the front wheel or R denoting the rear wheel. Similar to the first embodiment, it is possible to calculate the total value of the tire longitudinal force Fxi for all the wheels 7 (two wheels) based on the longitudinal acceleration axse detected by the acceleration sensor 2.

From these equations, vehicle speed Vb, slip rate λi, and tire longitudinal force Fxi are found as expressed in equations (47) to (49), respectively.

$$\begin{matrix}[ Equation 45 ] & \\ {V}_{b} = \frac{{K}_{bf} {V}_{wF} {F}_{zF} + {K}_{bR} {V}_{wR} {F}_{zR}}{{ma}_{x} + {K}_{bF} {F}_{zF} + {K}_{bR} {F}_{zR}} & ( 47 )\end{matrix}$$

$$\begin{matrix}[ Equation 46 ] & \\ {λ}_{i} = \frac{\begin{matrix}{V}_{wi} ( \sum {F}_{xi} + {K}_{bF} {F}_{zF} + {K}_{bR} {F}_{zR} ) - \\ ( {K}_{bF} {V}_{wF} {F}_{zF} + {K}_{bR} {V}_{wR} {F}_{zR} )\end{matrix}}{{K}_{bF} {V}_{wF} {F}_{zF} + {K}_{bR} {V}_{wR} {F}_{zR}} & ( 48 )\end{matrix}$$

$$\begin{matrix}[ Equation 47 ] & \\ {F}_{xi} = {K}_{bi} ( \frac{\begin{matrix}{V}_{wi} ( \sum {F}_{xi} + {K}_{bF} {F}_{zF} + {K}_{bR} {F}_{zR} ) - \\ ( {K}_{bF} {V}_{wF} {F}_{zF} + {K}_{bR} {V}_{wR} {F}_{zR} )\end{matrix}}{{K}_{bF} {V}_{wF} {F}_{zF} + {K}_{bR} {V}_{wR} {F}_{zR}} ) & ( 49 )\end{matrix}$$

Assuming that the front and rear wheels 7 have the same braking coefficient Kb (Kbi=Kb), equations (47) through (49) can be expressed as equations (50) through (52), respectively.

$$\begin{matrix}[ Equation 48 ] & \\ {V}_{b} = \frac{{K}_{b} ( {V}_{wF} {F}_{zF} + {V}_{wR} {F}_{zR} )}{\sum {F}_{xi} + {K}_{b} ( {F}_{zF} + {F}_{zR} )} & ( 50 )\end{matrix}$$

$$\begin{matrix}[ Equation 49 ] & \\ {λ}_{i} = \frac{{V}_{wi} ( \sum {F}_{xi} + {m}_{b} {K}_{b} g ) - ( {K}_{b} ( {V}_{wF} {F}_{zF} + {V}_{wR} {F}_{zR} ) )}{{K}_{b} ( {V}_{wF} {F}_{zF} + {V}_{wR} {F}_{zR} )} & ( 51 )\end{matrix}$$

$$\begin{matrix}[ Equation 50 ] & \\ {F}_{xi} = ( \frac{{V}_{wi} ( \sum {F}_{xi} + {m}_{b} {K}_{b} g ) - ( {K}_{b} ( {V}_{wF} {F}_{zF} + {V}_{wR} {F}_{zR} ) )}{{V}_{wF} {F}_{zF} + {V}_{wR} {F}_{zR}} ) {F}_{zi} & ( 52 )\end{matrix}$$

When the vehicle 10 uses a rear-wheel drive, the brake torque suchlike estimation unit 26 can find the vehicle speed Vb using equation (53), assuming that the slip rate λF for the front wheel is almost zero.

[Equation 51]

V_{b}=V_{wF} (53)

Using equation (53), the brake torque suchlike estimation unit 26 can find the slip rate λR for the rear wheel as expressed in equation (54).

$$\begin{matrix}[ Equation 52 ] & \\ {λ}_{R} = \frac{{V}_{wR} - {V}_{wF}}{{V}_{wR}} & ( 54 )\end{matrix}$$

Using this slip rate AR, the brake torque suchlike estimation unit 26 can find the tire longitudinal force FxR for the rear wheel according to equation (55).

[Equation 53]

F_{xR}=K_{b}λ_{R}F_{zR} (55)

Similar to the first embodiment, the total value of the tire longitudinal force Fxi for all the wheels 7 can be found from the longitudinal acceleration axse (or the longitudinal acceleration ax of the vehicle 10) detected by the acceleration sensor 2. When the vehicle 10 is two-wheeled, the total value of the tire longitudinal force Fxi coincides with the tire longitudinal force FxR of the rear wheel. The tire longitudinal force FxR of the rear wheel is expressed by equation (56), for example.

[Equation 54]

F_{xR}=m_{b}aₓ (56)

Consequently, the brake torque suchlike estimation unit 26 can find the braking coefficient Kb using equation (57) based on equation (29).

$$\begin{matrix}[ Equation 55 ] & \\ {K}_{b} = \frac{{F}_{xR}}{{F}_{zR}} \frac{{V}_{wR}}{{V}_{wR} - {V}_{wF}} & ( 57 )\end{matrix}$$

The tire load estimation unit 21 can find the tire load Fzi (tire vertical force Fzi) as expressed in equations (58) and (59) based on equations (21) and (22).

$$\begin{matrix}[ Equation 56 ] & \\ {F}_{zF} = \frac{{m}_{b}}{{L}_{bas}} ( {L}_{R} g - {h}_{yc} {a}_{x} ) & ( 58 )\end{matrix}$$

$$\begin{matrix}[ Equation 57 ] & \\ {F}_{zR} = \frac{{m}_{b}}{{L}_{bas}} ( {L}_{F} g + {h}_{yc} {a}_{x} ) & ( 59 )\end{matrix}$$

As described above, even if the vehicle 10 is two-wheeled, the brake torque estimation device 20 according to the first through ninth embodiments can highly accurately estimate the brake torque and control the motion of the vehicle 10 at a low cost.

The present invention is not limited to the above-described embodiments but is capable of various modifications. For example, the above-described embodiments have been described in detail in order to facilitate the understanding of the present invention, and the present invention is not necessarily limited to those including all of the described configurations. In addition, part of the configuration of one embodiment can be replaced with the configurations of other embodiments. In addition, the configuration of the one embodiment can also be added with the configurations of other embodiments. In addition, part of the configuration of each of the embodiments can be subjected to addition, deletion, and replacement with respect to other configurations.

### LIST OF REFERENCE SIGNS

1: wheel speed sensor, 2: acceleration sensor, 3: gyro sensor, 4: steering angle sensor, 5: controller, 7: wheel, 8: vehicle body, 9, 9FL, 9FR, 9RL, 9RR: brake device, 10: vehicle, 11: brake pedal, 12: communication line, 13: electric wire, 14: power source, 20: brake torque estimation device, 21: tire load estimation unit, 22: tire characteristics estimation unit, 24: tire characteristics storage unit, 25: tire characteristics reading unit, 26: brake torque suchlike estimation unit, 28: tire characteristics map, 30: curve indicating relationship between slip rate and friction coefficient, 31: curve indicating linear relationship between slip rate and friction coefficient, 42: disc rotor, 43: brake caliper, 44: housing, 45a, 45b: brake pad, 46: piston, 48: electric motor, 49: reducer, 50: rotary-linear conversion mechanism, 51: brake control device, 52: control signal line, 61: control signal line, 62, 63: communication line, 67: brake torque position command conversion unit, 72: brake torque position relationship generation unit, 74: position current control unit, 91: current sensor, 92: motor position sensor, ax: longitudinal acceleration, axse: longitudinal acceleration, Fxi: tire longitudinal force, Fzi: tire load (tire vertical force), Ii: inertia moment of wheel, Kb, Kbi: braking coefficient, mb: mass of the vehicle, Tbi: brake torque, Tbir: brake torque command, Vb: vehicle speed, Vwi: wheel speed, Vwsi: wheel speed measured by sensor, Ri: tire radius, ωi: wheel angular velocity, λi: slip rate

1. A brake torque estimation device capable of being provided for a vehicle including a plurality of wheels with tires, comprising:
a brake torque calculation unit to calculate the brake torque of the wheel,
wherein a wheel speed of the wheel and longitudinal acceleration of the vehicle are input; and
wherein the brake torque calculation unit calculates a vehicle speed, the tire longitudinal force of the wheel, and the slip rate of the wheel based on the wheel speed, tire load on the wheel, the longitudinal acceleration, and tire characteristics of the wheel and calculates the brake torque based on the calculated tire longitudinal force.

2. The brake torque estimation device according to claim 1, comprising:
a tire load estimation unit to calculate the tire load using the longitudinal acceleration.

3. The brake torque estimation device according to claim 1, comprising:
a tire characteristics estimation unit that finds the relationship between a slip rate and a friction coefficient as the tire characteristics.

4. The brake torque estimation device according to claim 3,
wherein the tire characteristics estimation unit finds, as the tire characteristics, a braking coefficient which is a proportionality coefficient between the slip rate and the friction coefficient, and finds the braking coefficient based on the longitudinal acceleration, the wheel speed, and the tire load when the vehicle accelerates.

5. The brake torque estimation device according to claim 1,
wherein the vehicle includes an electric motor or an internal combustion engine to generate a braking force and a brake device to generate a braking force; and
wherein the brake torque calculation unit calculates the brake torque when at least one of the following six conditions is satisfied:
1) the longitudinal acceleration of the vehicle falls within a predetermined range;
2) the wheel speed falls within a predetermined range and the vehicle is traveling straight;
3) a road surface where the vehicle travels satisfies a predetermined condition;
4) the torque generated by the electric motor is smaller than a predetermined threshold;
5) the torque generated by the internal combustion engine is smaller than a predetermined threshold; and
6) the brake device is active.

6. The brake torque estimation device according to claim 1,
wherein the vehicle includes an electric motor or an internal combustion engine to generate a braking force and a brake device to generate a braking force; and
wherein the brake torque calculation unit finds the brake torque generated by the brake device by subtracting torque generated by the electric motor or the internal combustion engine from the calculated brake torque.

7. The brake torque estimation device according to claim 1,
wherein the vehicle includes an electric motor or an internal combustion engine to generate a braking force and a brake device to generate a braking force; and
wherein the brake torque calculation unit finds the torque generated by the electric motor or the internal combustion engine by assuming the calculated brake torque to be the torque generated by the electric motor or the internal combustion engine or by subtracting the measured brake torque generated by the brake device from the calculated brake torque.

8. The brake torque estimation device according to claim 1,
wherein, when the vehicle turns while traveling, the brake torque calculation unit calculates the brake torque using the lateral acceleration of the vehicle, a steering angle of the wheel, and the tire characteristics depending on a sideslip angle when the vehicle turns.

9. The brake torque estimation device according to claim 1 connected to a brake control device to control a brake device,
wherein the brake device is an electric brake device that is provided for the vehicle and includes an electric motor; and
wherein, when the brake torque is calculated, the brake control device stores at least one of the current of the electric motor and a rotational position of the electric motor.

10. The brake torque estimation device according to claim 3,
wherein, when finding the tire characteristics, the tire characteristics estimation unit acquires the condition of a road surface where the vehicle travels or weather information on a road where the vehicle travels.

11. The brake torque estimation device according to claim 1 connected to a brake control device to control a brake device,
wherein the brake device is provided for the vehicle and includes a brake pad and a disc rotor; and
wherein, when the brake torque is calculated, the brake control device stores the temperature of the brake pad and the revolution speed of the disc rotor.

12. The brake torque estimation device according to claim 3,
wherein the vehicle uses a front-wheel drive or rear-wheel drive; and
wherein the tire characteristics estimation unit finds, as the tire characteristics, a braking coefficient which is a proportionality coefficient between the slip rate and the friction coefficient, and finds the braking coefficient based on the tire longitudinal force, the wheel speed, and the tire load when the vehicle accelerates.

13. The brake torque estimation device according to claim 3,
wherein the vehicle uses a four-wheel drive; and
wherein the tire characteristics estimation unit finds, as the tire characteristics, a braking coefficient which is a proportionality coefficient between the slip rate and the friction coefficient, and finds the braking coefficient based on the longitudinal acceleration, a ratio of driving force between front and rear wheels, the wheel speed, and the tire load when the vehicle accelerates.
